(19) United States
(12) Patent Application Publication
(10) Pub. No.: US 2017/0041214 A1
(43) Pub. Date: Feb. 9, 2017

(54) WIDE AREA NETWORK, WAN, SENSING IGMP PROXY

(71) Applicant: THOMSON LICENSING, Issy-les-Moulineaux (FR)

(72) Inventor: Keith Robert BROERMAN, Carmel, IN (US)

(21) Appl. No.: 15/304,796

(22) PCT Filed: Apr. 10, 2015
(86) PCT No.: PCT/US2015/025303

§ 371 Date: Oct. 17, 2016

Related U.S. Application Data
(60) Provisional application No. 61/981,261, filed on Apr. 18, 2014.

(51) Int. Cl. H04L 12/707; H04L 12/751; H04L 12/28; H04L 12/703

(52) U.S. Cl. CPC H04L 45/22; H04L 45/28; H04L 45/02; H04L 12/2858

(57) ABSTRACT

A method, apparatus and system for implementing a wide area network sensing internet group management protocol proxy are provided. A message indicating an activation of an alternate wide area network interface, activated as a result of a failed primary wide area network interface, is received. A communication path to the failed wide area network interface is closed and a communication path to the alternate wide area network interface is created using information received in the message. Subsequently a join request is communicated to at least one client using the communication path created to communicate with the alternate wide area network interface.

### FIELD OF THE INVENTION

The present principles generally relate to network interfacing and more particularly to a method, apparatus and system for implementing a wide area network sensing internet group management protocol proxy.

### BACKGROUND OF THE INVENTION

Modern digital subscriber line (DSL) and fiber optic service (FiOS) home gateway/router devices support multiple WAN interfaces. For example, DSL gateways provide both DSL and gigabit Ethernet (GigE) WAN interfaces to connect to a service provider. Typically only one WAN interface is in use at any one time and the secondary WAN interface remains in standby until the primary interface is lost.

Home gateway/router devices typically provide internet group management protocol (IGMP) Proxy services whereby IGMP requests from LAN attached clients are proxied to the gateway's WAN interface. These requests initiate a downstream flow of multicast traffic (e.g., video, audio, etc.) from multicast routers located at the service provider or in the cloud, which is then forwarded by the gateway to the requesting LAN client.

A problem arises when the gateway's primary WAN interface is lost due to link or equipment failures. In this case the downstream flow of multicast packets to LAN clients is broken, resulting in video/audio disruption. If the home gateway has failed over to the secondary WAN interface then communication will remain disrupted since (1) the upstream multicast routers are not aware of the topology change and (2) the gateway's IGMP Proxy circuit is not aware of the new WAN interface.

### SUMMARY OF THE INVENTION

Embodiments of the present principles address these and other deficiencies of the prior art by providing a method, apparatus and system for implementing a wide area network sensing internet group management protocol proxy for minimizing the audio/video disruption problem that occurs when an access device's primary WAN interface fails over to a secondary interface. In various embodiments of the present principles an access device will alert an IGMP Proxy circuit of the failover and the proxy will examine a multicast routing database to reissue IGMP membership reports (joins) for existing groups on the new WAN interface. Such action results in audio/video reestablishment very shortly after the new WAN interface becomes active.

In one embodiment of the present principles, a method includes receiving a message indicating an activation of an alternate wide area network interface, activated as a result of a failed primary wide area network interface, closing a communication path to the failed wide area network interface, creating a communication path to the alternate wide area network interface using information received in the message and communicating a join request to at least one client using the communication path created to communicate with the alternate wide area network interface.

In an alternate embodiment of the present principles, an apparatus includes a host component in communication with at least a primary and an alternate wide area network via respective network interfaces and a router component in communication with a local area network via a local area network interface for communicating with a client. In such an embodiment, the host component senses an activation of the alternate wide area network interface, activated as a result of a failure of the primary wide area network interface, and communicates a message indicating the activation of the alternate wide area network interface to the router component via a dedicated communication path; the message includes information regarding at least communication parameters of the alternate wide area network interface. In addition, the router component receives the message indicating the activation of the alternate wide area network interface, closes a communication path to the failed wide area network interface, creates a communication path to the alternate wide area network interface using information received in the message, and communicates a join request to the client using the communication path created to communicate with the alternate wide area network interface.

In an alternate embodiment of the present principles, a system includes a primary wide area network, an alternate wide area network, a local area network and an access device. In one embodiment, the access device includes a host component in communication with at least a primary and an alternate wide area network via respective network interfaces and a router component in communication with a local area network via a local area network interface for communicating with a client. In such an embodiment, the host component senses an activation of the alternate wide area network interface, activated as a result of a failure of the primary wide area network interface, and communicates a message indicating the activation of the alternate wide area network interface to the router component via a dedicated communication path; the message includes information regarding at least communication parameters of the alternate wide area network interface. In addition, the router component receives the message indicating the activation of the alternate wide area network interface, closes a communication path to the failed wide area network interface, creates a communication path to the alternate wide area network interface using information received in the message, and communicates a join request to the client using the communication path created to communicate with the alternate wide area network interface.

### BRIEF DESCRIPTION OF THE DRAWINGS

The teachings of the present principles can be readily understood by considering the following detailed description in conjunction with the accompanying drawings, in which:

FIG. 1 depicts a high level block diagram of a system in accordance with an embodiment of the present principles;

FIG. 2 depicts a high level block diagram of an access device suitable for implementation in the system of FIG. 1 in accordance with an embodiment of the present principles; and

FIG. 3 depicts a flow diagram of a method in accordance with an embodiment of the present principles.

It should be understood that the drawing(s) are for purposes of illustrating the concepts of the various described principles and are not necessarily the only possible configuration for illustrating the principles.

To facilitate understanding, identical reference numerals have been used, where possible, to designate identical elements that are common to the figures.

### DETAILED DESCRIPTION OF THE INVENTION

Embodiments of the present principles advantageously provide a method, apparatus and system for implementing a wide area network sensing internet group management protocol proxy. Although the present principles will be described primarily within the context of gateways, the specific embodiments of the present principles should not be treated as limiting the scope of the invention. It will be appreciated by those skilled in the art and informed by the teachings of the present principles that the concepts of the present principles can be advantageously applied to any access devices such as routers, set-top boxes, etc.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

Furthermore, because some of the constituent system components and methods depicted in the accompanying drawings can be implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

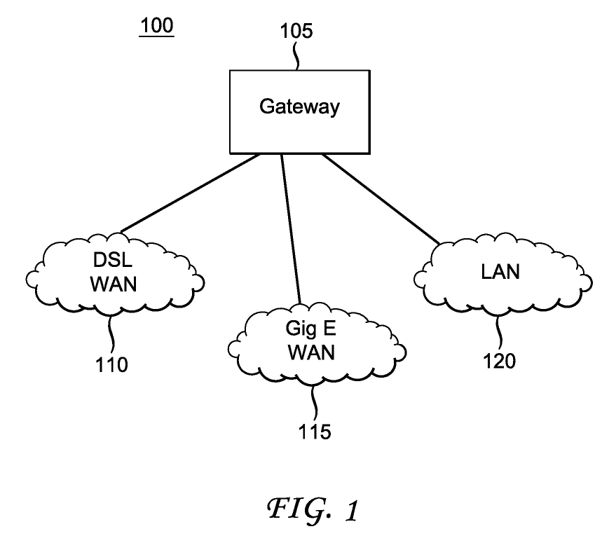

FIG. 1 depicts a high level block diagram of a system 100 for implementing a wide area network sensing internet group management protocol proxy in accordance with an embodiment of the present principles. The system 100 of FIG. 1 illustratively includes an access device 105 (illustratively a gateway) and a DSL WAN 110, a GigE WAN 115 and a LAN 120 all in communication with the Gateway device 105. Although in the embodiment of FIG. 1 the access device illustratively comprises a Gateway device 105, in alternate embodiments of the present principles an access device can include other access devices such as a set-top box, a router, and the like.

In the system of FIG. 1, the Gateway device 105 supports multiple WAN interfaces. For example, in the system of FIG. 1, the Gateway device 105 provides both DSL (digital subscriber line) and GigE (gigabit Ethernet) WAN interfaces to connect to a service provider.

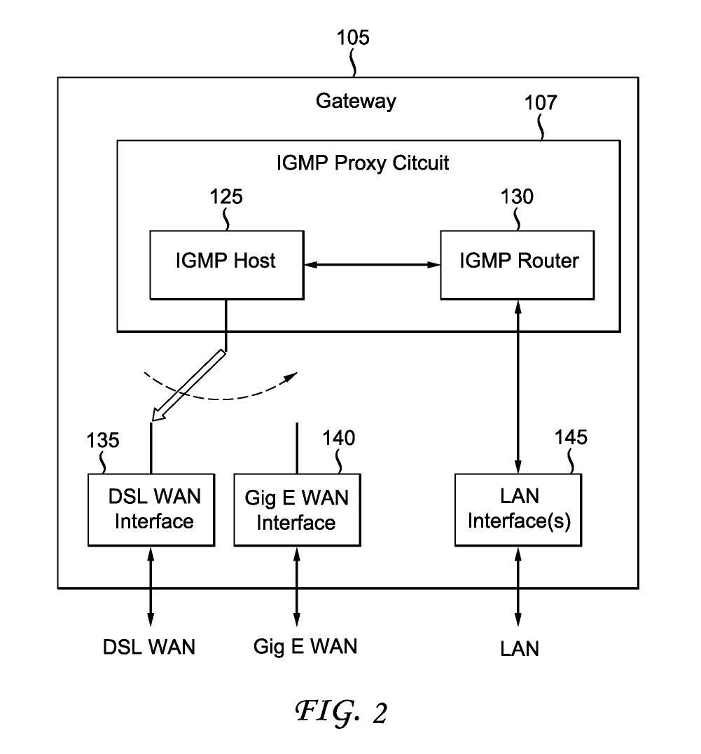

FIG. 2 depicts a high level block diagram of a gateway access device suitable for implementation in the system of FIG. 1 in accordance with an embodiment of the present principles. The Gateway device 105 of FIG. 2 illustratively comprises a Proxy circuit 107 (illustratively an IGMP Proxy circuit) including a Host Component 125 (illustratively an IGMP Host Component) and a Router Component 130 (illustratively an IGMP Router Component), a DLS WAN interface 135, a GigE WAN interface 140 and a LAN interface 145. Although in FIG. 2 the IGMP Host Component 125 and the IGMP Router Component 130 are depicted as comprising components of a IGMP Proxy circuit 107, in alternate embodiments of the present principles, the IGMP Host Component 125 and the IGMP Router Component 130 can comprise separate components of an access device and not necessarily included in a IGMP Proxy circuit 107. In alternate embodiments, the IGMP Host Component 125 and the IGMP Router Component 130 can comprise an integrated component/circuit comprising all of the functionality of the individual components.

In the system of FIG. 1 and referring to the Gateway device 105 of FIG. 2, IGMP requests from clients attached to the LAN 120 are proxied to the Gateway device's WAN interfaces 110, 115. These requests initiate a downstream flow of multicast traffic (video, audio, etc) from multicast routers located at the service provider or in the cloud, which is then forwarded by the Gateway device 105 to the requesting client attached to the LAN interface 120.

Typically, when a primary WAN interface is lost due to link or equipment failures, the downstream flow of multicast packets to LAN clients is broken, resulting in video/audio disruption. If a home access device has failed over to a secondary WAN interface then video will remain disrupted since (1) the upstream multicast routers are not aware of the topology change and (2) the access device's IGMP Proxy circuit is not aware of the secondary WAN interface.

In various embodiments of the present principles, when a primary WAN interface fails over to a secondary WAN interface an access device in accordance with the present principles alerts an IGMP Proxy circuit of the failover, and the IGMP Proxy circuit examines a multicast routing database to reissue IG MP membership reports (joins) for existing groups on the secondary WAN interface. Such functionality results in audio/video reestablishment very shortly after a secondary WAN interface becomes active, which minimizes audio/video disruption during loss of a primary WAN interface due to, for example, line or equipment failures.

As illustrated in the system 100 of FIG. 1 and referring to the Gateway device 105 of FIG. 2, the IGMP Proxy circuit 107 of the Gateway device 105 includes a WAN-facing IGMP Host Component 125 and a LAN-facing IGMP Router Component 130. In the embodiment of FIG. 1, the WAN-facing IGMP Host Component 125 communicates with the WAN interfaces 110, 115 using a socket w/file descriptor W, and the LAN-facing IGMP Router Component 130 communicates with LAN clients via the LAN interface 120 using a second socket w/file descriptor L. In accordance with an embodiment of the present principles, the IGMP Router Component 130 is enhanced to listen not only on the LAN interface socket, L, but also for event messages sent to a new socket/file descriptor, E, in accordance with an embodiment of the present principles. In such embodiments of the present principles, the access device sends a link up message to socket E when a secondary WAN interface becomes active. For example, in the embodiment of FIG. 2, the IGMP Host Component 125 communicates a message to the IGMP Router Component 130, for example via new socket/file descriptor, E, when the IGMP Host Component 125 senses that a secondary WAN interface becomes active in response to a failed primary WAN interface. When the IGMP Router Component 130 receives the message indicating that a secondary WAN interface has become active it can perform at least one of the following functions:
1. the IGMP Router Component 130 closes its original socket W to the failed WAN interface;
2. the IGMP Router Component 130 creates a new socket W′ to the new WAN interface, using information from the event message received from socket E; and
3. for each multicast route table entry in the IGMP router's database, the IGMP Router Component 130 issues a IGMP membership report (join). These join requests are sent to the new WAN interface via the socket W′ created in step 2, above.

As a result of Step 3, IGMP joins are re-constituted for all currently active groups and are sent upstream thru the new WAN interface. The upstream multicast routers receive the requests and stream the requested content thru the updated network topology. As a result, LAN client audio/video service is quickly resumed.

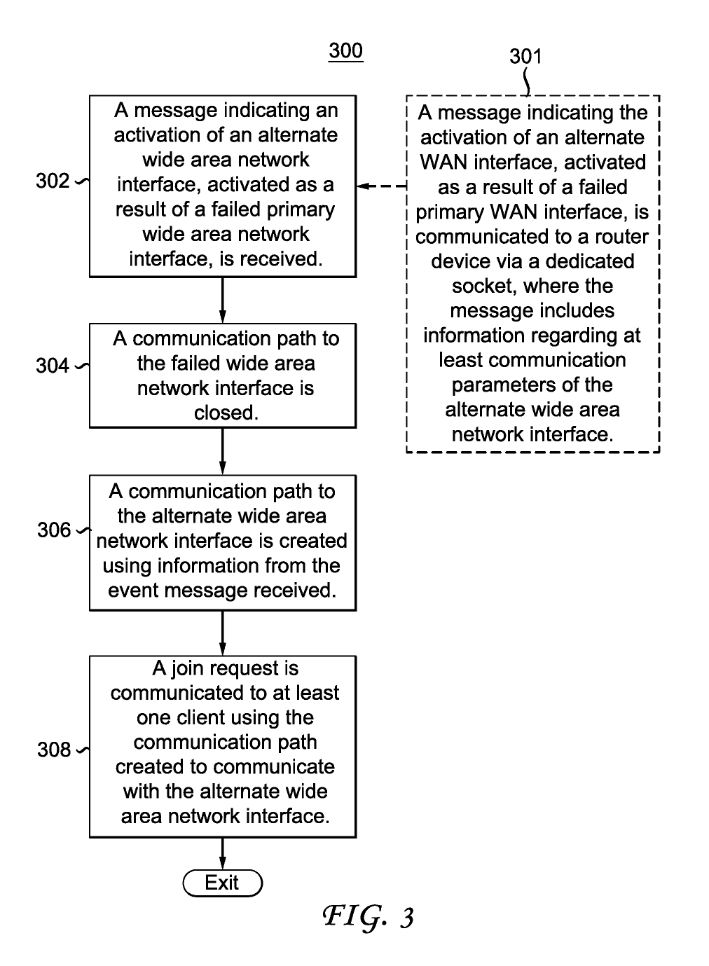

FIG. 3 depicts a flow diagram of a method 300 in accordance with an embodiment of the present principles. More specifically, FIG. 3 depicts a flow diagram 300 of a method for implementing a wide area network sensing internet group management protocol proxy in accordance with an embodiment of the present principles. The method 300 begins at step 302 during which an event message is received indicating the activation of an alternate WAN interface, activated as a result of a failed primary WAN interface. For example and as described above, in one embodiment of the present principles, a host component of an access device such as the IGMP Host Component 125 of the gateway device 105 of FIG. 1 senses the activation of an alternate WAN interface and communicates a message to the IGMP Router Component 130 including information regarding such activation. The method 300 can then proceed to step 304.

At step 304, a socket to the failed WAN interface is closed. For example and as described above, in one embodiment of the present principles, a router component of an access device such as the IGMP Router Component 130 of the gateway device 105 previously communicating with the failed WAN interface closes a socket used to communicate with the failed WAN interface. The method 300 can then proceed to step 306.

At step 306, a socket to the alternate WAN interface is created using information from the event message received. For example and as described above, in one embodiment of the present principles, a router component of an access device such as the IGMP Router Component 130 of the gateway device 105 creates a socket to communicate with the alternate WAN interface. The method 300 can then proceed to step 308.

At step 308, a join request is communicated to at least one client using the socket created to communicate with the alternate WAN interface. For example and as described above, in one embodiment of the present principles, for each multicast route table entry in the IGMP Router's database, the IGMP Router Component 130 issues an IGMP membership report (join requests), which are communicated using the new socket created to communicate with the alternate WAN interface. The method 300 can then be exited.

The method 300 can further include optional step 301 which includes communicating an event message indicating the activation of an alternate WAN interface, activated as a result of a failed primary WAN interface, to a router device via a dedicated socket, where the event message includes information regarding at least communication parameters of the alternate WAN interface.

Having described various embodiments of a method, apparatus and system for implementing a wide area network sensing internet group management protocol proxy for minimizing the audio/video disruption problem that occurs when a gateway primary WAN interface fails over to a secondary interface (which are intended to be illustrative and not limiting), it is noted that modifications and variations can be made by persons skilled in the art in light of the above teachings. It is therefore to be understood that changes can be made in the particular embodiments of the principles disclosed which are within the scope and spirit of the invention. While the forgoing is directed to various embodiments of the present principles, other and further embodiments of the invention can be devised without departing from the basic scope thereof.

1. A method comprising the steps of:
receiving a message indicating an activation of an alternate wide area network interface, activated as a result of a failed primary wide area network interface;
closing a communication path to the failed wide area network interface;
creating a communication path to the alternate wide area network interface using information received in the message; and
communicating a join request to at least one client using the communication path created to communicate with the alternate wide area network interface.

2. The method of claim 1, wherein the activation of the alternate wide area network interface is sensed by a host component and the indication of the activation is communicated to a router component of an access device.

3. The method of claim 1, comprising communicating a message indicating the activation of the alternate wide area network interface, activated as a result of the failed primary wide area network interface, to a router device via a dedicated communication path, wherein the message includes information regarding at least communication parameters of the alternate wide area network interface.

4. An apparatus, comprising:
a host component in communication with at least a primary and an alternate wide area network via respective network interfaces; and
a router component in communication with a local area network via a local area network interface for communicating with a client;
wherein said host component senses an activation of the alternate wide area network interface, activated as a result of a failure of the primary wide area network interface, and communicates a message indicating the activation of the alternate wide area network interface to the router component via a dedicated communication path, wherein the message includes information regarding at least communication parameters of the alternate wide area network interface; and
wherein said router component receives the message indicating the activation of the alternate wide area network interface, closes a communication path to the failed wide area network interface, creates a communication path to the alternate wide area network interface using information received in the message, and communicates a join request to the client using the communication path created to communicate with the alternate wide area network interface.

5. The apparatus of claim 4, wherein said apparatus comprises an access device.

6. The apparatus of claim 5, wherein said access device comprises a set top box.

7. The apparatus of claim 5, wherein said access device comprises a gateway.

8. The apparatus of claim 4, wherein said host component comprises an internet group management protocol host component.

9. The apparatus of claim 4, wherein said router component comprises an internet group management protocol router component.

10. The apparatus of claim 4, wherein said host component and said router component comprise a proxy circuit.

11. A system, comprising:
a primary wide area network;
an alternate wide area network;
a local area network; and
an access device, comprising:
a host component in communication with the primary wide area network and the alternate wide area network via respective network interfaces; and
a router component in communication with the local area network via a local area network interface for communicating with at least one client via the local area network;
wherein said host component senses an activation of the alternate wide area network interface, activated as a result of a failure of the primary wide area network interface, and communicates a message indicating the activation of the alternate wide area network interface to the router component via a dedicated communication path, wherein the message includes information regarding at least communication parameters of the alternate wide area network interface; and
wherein said router component receives the message indicating the activation of the alternate wide area network interface, closes a communication path to the failed wide area network interface, creates a communication path to the alternate wide area network interface using information received in the message, and communicates a join request to the at least one client using the communication path created to communicate with the alternate wide area network interface.

12. The system of claim 11, wherein said primary wide area network comprises one of a digital subscriber line network and a gigabit Ethernet network.

13. The system of claim 11, wherein said alternate wide area network comprises one of a digital subscriber line network and a gigabit Ethernet network.
